(19) United States
(12) Patent Application Publication
(10) Pub. No.: US 2002/0059431 A1
(43) Pub. Date: May 16, 2002

(54) Communication apparatus, server, service center, and service method

(76) Inventor: Masahiro Terada, Asaka-shi (JP)

Correspondence Address: BIRCH STEWART KOLASCH & BIRCH, PO BOX 747, FALLS CHURCH, VA, 22040-0747, US

(21) Appl. No.: 09/917,729

(22) Filed: Jul. 31, 2001

(30) Foreign Application Priority Data
Jul. 31, 2000 (JP) 2000-231829

(51) Int. Cl. G06F 15/16

(52) U.S. Cl. 709/227

(57) ABSTRACT

A communication apparatus, a server, a service center, and a method for the service of the present invention comprise a communication means which receives an image and identification information of an electronic camera itself owned by a user, a display means which displays the received image and a service menu provided by respective service centers, a selecting means by which the user selects a desired image as well as a desired service, and another communication means which transmits via a network the identification information of the electronic camera itself, the selected image, and the service data. Therefore, the user can easily transmit a visual or an audio file and the identification information of the electronic camera itself to a desired server or a service center.

### BACKGROUND OF THE INVENTION

1. Field of the Invention

The present invention relates to a communication apparatus, a server, a service center, and a service method, particularly to those in which image or audio data is transmitted through a network.

2. Description of the Related Art

Conventionally, to order prints of images taken with an electronic camera, a user records the images in a personal computer, stores image files and an order information file in a storage medium, and then brings the storage medium to a shop offering print service. Alternatively, the user visits a printing service website, inputs information including a user ID and a print receiving location, and transmits the image files.

As the Internet has come into wide use, various image service websites have been opened.

However, because software for viewing an image with a personal computer is generally different from software for ordering the prints, service information and desired image files are not well-connected and the user needs a complicated operation to transmit the image files. Software for both viewing the images and ordering the prints has a limited application because it is only used for certain simple services.

Further, the user needs a complicated input operation for confirming information related to a method of payment, and the user has to find an image service website for images taken with the user's electronic camera.

When the user transmits the image files to a service center on the Internet, the service center can not obtain user information including an address and a name of the user. Thus, each time the user orders prints, the user has to input the user information.

### SUMMARY OF THE INVENTION

The present invention has been developed in view of the above-described circumstances, and has as its object the provision of a communication apparatus, a server, a service center and a service method in which the server or the service center can easily obtain user information of a user.

In order to achieve the above-described objects, the present invention is directed to a communication apparatus comprising: a first communication device that receives images and identification information of a camera owned by a user from the camera; a displaying device that displays the images received from the camera by the first communication device and displays a service menu showing services offered by a service center for the user; a selecting device that selects an image among the images displayed by the displaying device and selects a service among the services displayed by the displaying device; and a second communication device that transmits the identification information, the image and information indicating the service to the service center through a network. Thus, the user can easily transmit an image or audio file and the identification information to a server or the service center.

Moreover, in order to achieve the above-described objects, the present invention is directed to a server comprising: a communication device that receives identification information of a camera owned by a user from the user; a recording device that records the identification information and a service menu showing services to be offered to the user; and a reading device that reads the service menu from the recording device according to the identification information; wherein the communication device transmits the service menu to the user. Thus, a server (or a service center) can select the service menu recorded with the identification information to provide the service menu to the user.

Further, a service center, comprising: a communication device that receives identification information of a camera owned by a user and service information, or the identification information, an image and the service information from the user; a recording device that records the identification information and user information on the user; and a device that reads the user information from the recording device according to the identification information received by the communication device to specify the user, and provides a service corresponding with the service information to the user. Thus, the service center can select the user information recorded with the identification information to distribute or deliver goods to a desired location.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a view showing a structure and a connecting state of a service system which is used when a user transfers an image to a server;

FIG. 2 is a view showing a flow of communication of information which is exchanged between an electronic camera and a service center;

FIG. 3 is a view showing a display screen of an image viewer which is displayed on a display means of a personal computer;

FIG. 4 is a view of a structure of a service system for transmitting user setting information inputted by a user and identification information of an electronic camera itself;

FIG. 5 is a view showing an example for activating a service system of the present invention;

FIG. 6 is a flowchart for a process of a personal computer associated with an event which occurs at a time of connecting an electronic camera with a cradle;

FIG. 7 is a flowchart associated with activation of an image viewer and a presentation of a menu which is provided by “FutureGate”; and

FIG. 8 is a flowchart associated with execution of “FutureGate” menu of an image viewer.

### DETAILED DESCRIPTION OF THE PREFERRED EMBODIMENTS

Hereunder preferred embodiments will be described in detail of a communication apparatus, a server, a service center, and a method for the service of the present invention in accordance with the accompanied drawings.

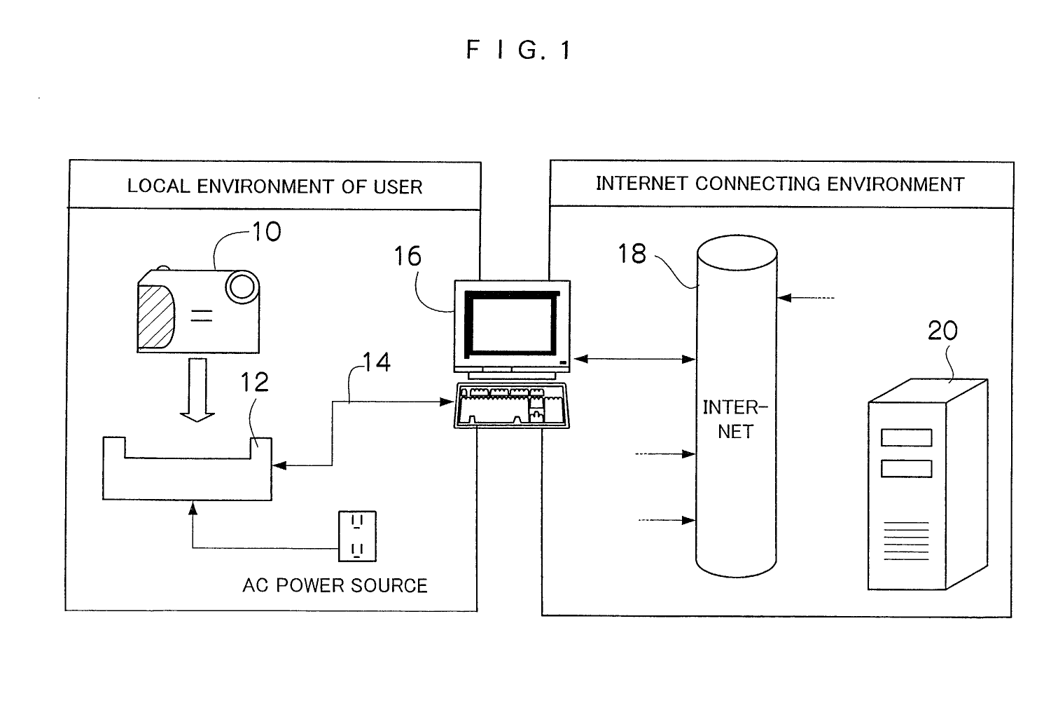

FIG. 1 is a view showing a structure and a connecting state of a service system which is used when a user transmits an image to a server.

The service system in FIG. 1 comprises an electronic camera 10 which can record identification information of a camera itself, user setting data set by the user, and a taken image, and which has a communication means for transmitting those recorded data to another communication apparatus, a cradle 12 as a linking facility which connects and communicates to the communication means and can supply power to the electronic camera 10, a personal computer 16 which can exchange data such as an image with the cradle 12 through a communication means 14 such as a USB (a communication means accorded by a communication standard of Universal Serial Bus), and at the same time which serves as a communication apparatus with a communication means for exchanging data such as an image with a server and a service center through a communication network, and a service center 20 such as a server which can exchange data such as an image or audio data through a communication network such as the Internet 18.

With the service system constructed as described above, the electronic camera 10 can thereby exchange data such as an image with the service center 20 through the personal computer 16. Note that the cradle 12 serves for simplifying an operation of the user by replacing a power supply connector and an interface connector of the personal computer 16 with a connector at an upper hierarchy.

Moreover, the electronic camera 10 is provided at least with an imaging means for taking a subject, a record means for recording an image and sound, and a communication means for exchanging data with other communication apparatuses. The personal computer 16 (a communication apparatus) comprises a communication means for exchanging data with the electronic camera 10, a communication means which can exchange data with a communication network such as the Internet 18, a display means for displaying respective visual and audio identification information to the user, and also displaying data such as a service menu provided by each of the service centers 20, 20, . . . , pickup means for picking up an image or sound which the user desires to be served among the displayed visual and audio identification information, selecting means for selecting a service which is desired by the user among the displayed data such as the service menu, and a record means in which the respective execution programs and data are recorded.

The server such as the service center 20 comprises: a communication means for exchanging respective data with the communication network such as the Internet 18; a record means for recording the data such as the following in association with the identification information of the electronic camera 10 itself: user setting data, utility data, service menu data, a password, a method of payment for the utilization charge which is paid by the user of the electronic camera 10; a pickup means for picking up the respective data based on the identification information of the electronic camera 10 itself; a verification means for verifying the password and accepting or rejecting provision of the service; a payment data record means in which the identification information of the electronic camera 10 itself owned by the user and a method of payment for the utilization charge paid by the user are recorded; a payment data pickup means for picking up a method of payment for the utilization charge from the payment data record means based on the identification information of the electronic camera 10 itself; a payment receipt means for accepting the utilization charge for the service to be provided to the user in accordance with the picked up payment method for the utilization charge; and a determination means for determining an order of priority for displaying the plural services to be provided to the user in accordance with the service utility data of the user.

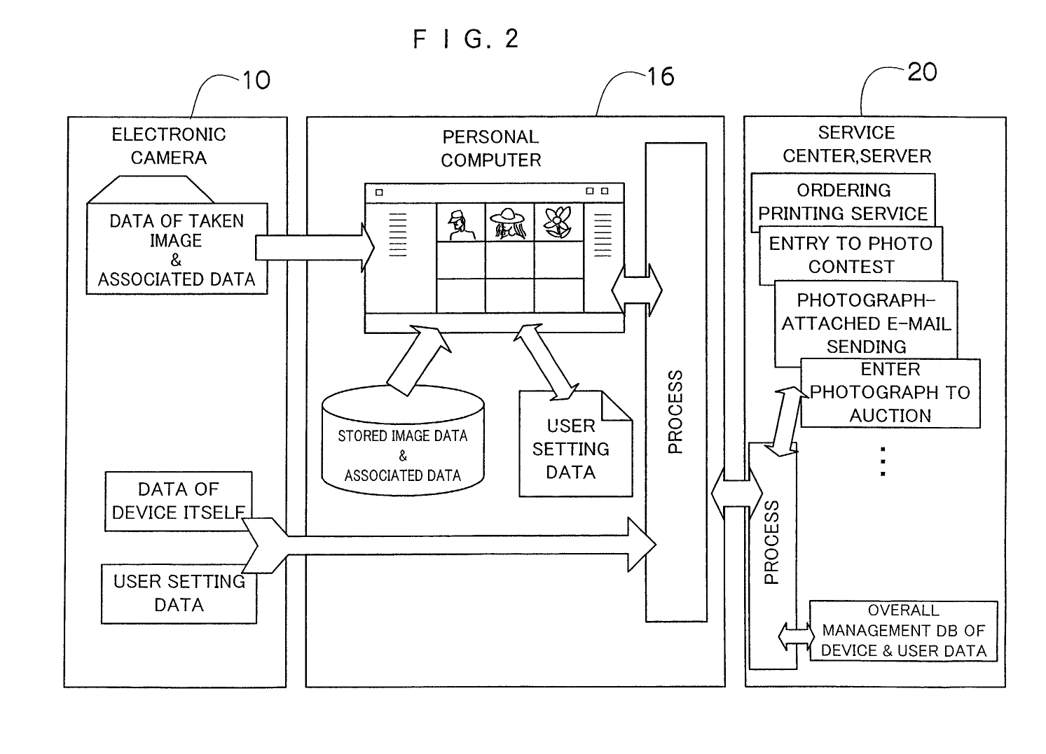

FIG. 2 shows a flow of data which is exchanged between the electronic camera and the service center.

In FIG. 2, the electronic camera 10 can transmit the following data to the personal computer 16 through the communication means 14: image data being taken and its associated data, identification information of the electronic camera 10 itself such as a product serial number or an ID number, and user setting data such as an address and a credit card number which can be customized by one user.

When the electronic camera 10 is inserted into the cradle 12, the personal computer 16 automatically detects (by use of “Plug & Play function”) connection of the electronic camera 10 through the communication means such as a USB, and automatically activates an image viewer, which is an application software for displaying all images at once within the electronic camera 10. Presenting an example of a function for automatically detecting the connection of the electronic camera 10, a device driver is built in beforehand for automatically detecting the connection of the electronic camera 10 at or after a time of system program activation of the personal computer 16, and the Plug & Play event of the communication system is monitored. When the device driver recognizes the connection of the electronic camera 10, the device driver activates a required process program such as an image viewer in response to a process mode of the electronic camera 10.

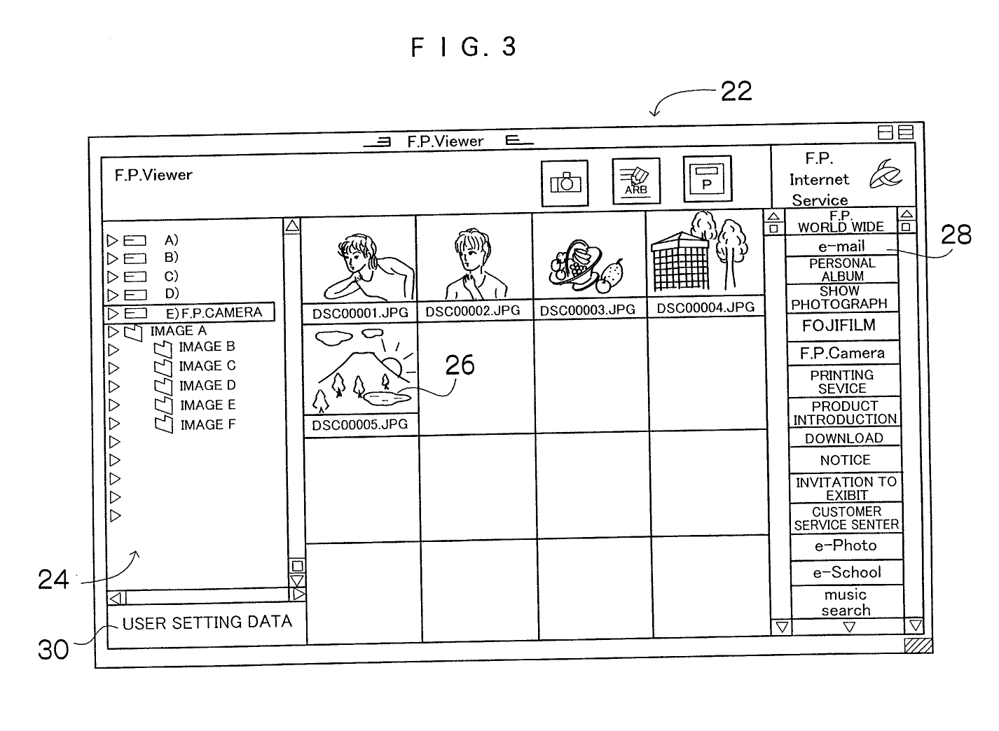

FIG. 3 shows a display screen of the image viewer which is displayed on the display means of the personal computer.

A display screen 22 (the display means of the personal computer 16) which is displayed by the image viewer displays the following data at the same time: data of a taken image and the identification information of the associated data, a file list 24 in which data of a stored image, a folder name of the associated data, and identification information of a file name recorded in a database of the personal computer 16 are recited (stored), an overall display for displaying reduced images of the respective images 26 (identification information based on thumbnail images) which are recorded within a folder at which the user instructs to look, respective instruction buttons 28 (selecting means) for displaying the respective services in a form of a menu and instructing connecting with the service center 20 which performs the respective services, and a user setting data button 30 with which the user can confirm or correct the user setting data inputted and set previously by the user.

If the data recorded in the folder at which the user instructs to look is audio data only, a service menu of the service center 20 such as a music site regarding music is only displayed. If the recorded data is visual data only or if the electronic camera 10 does not have an audio reproducing function (that is, a menu is selected based on the data of the electronic camera 10 which is recorded in the server of the service center 20 in association with the received identification information of the camera itself), only a service menu of the service center 20 related to the image without displaying unnecessary data, so that less number of options are available and the system can be easily used by the user.

The user selects the desired image or images from the overall view of the displayed file name or the reduced images 26 by using an input means (i.e. a selecting means), usually a mouse or keyboards, and presses the instruction button 28 (e.g. service selecting means such as a printing service button, a button for publicly showing the photograph, and photo contest entry button) for instructing connecting to and transmitting data to the respective service centers 20. The user can thereby transmit printing service data of the desired image, use a service to publicly show the photograph on the Internet, and upload an image file or audio file in order to enter to a photo contest, only by performing the above-described process.

The visual and audio data which are selected in the manner as described above and the data related to the services which are desired to be performed at the service center 20 are linked in an application program of the image viewer, and are transmitted to the service center 20 which is instructed with the instruction button 28. If the personal computer 16 and a provider such as the Internet are connected through a public telephone line, the personal computer 16 performs dial-up so as to start communicating with the provider, the Internet, when the user selects and instructs the visual and audio data and the service center. Then, the following data are transmitted: data related to an IP address or a domain name of the service center 20 to be connected and data related to an IP address or a domain name assigned to the personal computer 16, the desired service data, selected visual and audio data, and the identification information of the electronic camera 10 itself.

The service center 20 receives an IP address or a domain name of the personal computer 16, service data and visual and audio data, and the identification information of the electronic camera 10 itself, and transmits to the personal computer 16 the data of a predetermined operating screen based on the received service data (in other words, the service center 20 transmits directly to the personal computer 16 the following data: the data of the most relevant service menu corresponding with the identification information of the electronic camera 10 itself, the data of the most relevant service menu which is recorded in association with the identification information of the electronic camera itself and the utility data up to the present moment of the service center 20 or the server site, and the data of the service menu of a homepage which exists at the deepest level from the top page of the service center 20).

If the service center 20 needs a delivery location data of a product and payment data in such a case that the user instructs a printing service of an image, the personal computer 16 receives the unique data of the device (i.e. the data such as a product serial number and an ID number of the electronic camera 10 itself) which is inserted in the cradle 12 and at the same time automatically transmits the data to the service center 20.

Moreover, the following user setting data is registered in the electronic camera 10 at a time the user purchased the electronic camera 10: name, address, address to which a product is delivered to the user, visual or audio data of delivery address of the user, a password specifying the user, gender, birthday, age, and so forth; thereby, the data is transmitted beforehand to the service center 20 with a product serial number of the purchased electronic camera 10 itself at a time of registration of the user. Both of those numerous data are managed in the service center 20, and the above-mentioned user data which are recorded in association with the identification information of the electronic camera 10 itself are read out in order for the service center 20 to refer them for delivery and a payment of a product when the service center 20 receives the image data and the identification information of the electronic camera 10 itself. In that case, the electronic camera 10 serves as a verification device.

In another case where a person other than the user who purchased the electronic camera 10 operates it so as to receive the respective services, a system may be incorporated in which the service center 20 inquires a verification password to identify the user if a charge for the respective services occurs, in order to avoid a problem that the utilization charge of the respective services is actually charged to the user who purchased the electronic camera 10 but did not use the services this time. In that case, the service center records in the record means beforehand the user setting data including the identification information of the electronic camera 10 itself owned by the user and the password of the user in the record means.

Now, when the service center 20 receives the identification information of the electronic camera 10 itself and the password which is inputted by the user for this time, the service center 20 reads out the password which is recorded beforehand in the record means in association with the identification information of the electronic camera 10 itself, and the verification means verifies the read out password with the password which is inputted at this time. After the verification, if the password recorded beforehand in the record means is determined as the same as the password which is inputted by the user at this time, the verification means accepts and performs providing services such as transmitting visual or audio data, or processing for delivery of printed matter which are instructed from the user. As to the address data of the delivery location of the product, the address data of the delivery location is used which is included in the user setting data recorded beforehand in the record means in association with the identification information of the electronic camera 10 itself. If a method of payment for the utilization charge for the respective services provided by the service center 20 is included in the user setting data (that is, if the method of payment is recorded in a payment data record means), a payment data selecting means selects a method of payment for the utilization charge which is recited in the user setting data, that is recorded in association with the identification information of the electronic camera 10 itself, and the charge accepting means of the service center 20 accepts the utilization charge in accordance with a verification result of the method of payment for the utilization charge and with the password.

The data on the operating screen which the service center 20 transmits to and notifies the personal computer 16 may be a default typical operating screen, and contents of the operating screen may be changed based on the utility data such as frequency and history of use of the user. In order to change the operating screen, the utility data related to the frequency and contents of use which the user used the service center 20 is recorded in the record means in an order in association with the identification information of the electronic camera 10 itself which is received from the electronic camera 10 through the personal computer 16, and the latest operating screen may be informed to the user by selecting or customizing the data which is selected to be useful for an individual user from the plural types of utility data of the plural types of service centers 20 which are recorded in the record means in accordance with the current utility data and frequency plus content of use stored in a storage means. Further, an order of priority for display may be switched so that the data of the service center 20 with a high frequency of use is displayed earlier in accordance with the utility data recorded in association with the identification information of the electronic camera 10; alternatively, the user may display the service center 20 with a high frequency of use by oneself by taking a priority of the service center 20 in order to easily select it.

As described above, the user's own utility data and the data of the electronic camera 10 itself are recorded, whereby operation screens are displayed differently for the respective users in that, for example, an operation screen and advertisement data which are suitable for a user A are provided to the user A based on the identification information of a camera a, whereas the counterparts which are suitable for a user B are provided to the user B based on the identification of a camera b, even though in a case where the electronic camera a owned by the user A and the electronic camera b owned by the user B accessed and used the same image service center 20 by using the same personal computer 16. Therefore, more specified services can be provided corresponding with the users.

As to display in the image viewer which operates in the personal computer 16, the image viewer may display a service menu in accordance with the received display data by transmitting the data of the electronic camera 10 itself so as to inquire to the server of the image service center, and transmitting the display data of the service menu to the personal computer 16 in accordance with the user's own history data which is recorded in association with the data of the electronic camera 10 itself.

Further, the identification information of the electronic camera 10 itself, the status data of the electronic camera 10, and the history data of using the electronic camera 10 may be transmitted from the user's side to the service center 20, which performs an after-service of the electronic camera 10 in response to a request through a communication from the user's side; on the other hand, the service center 20 may transmit through the personal computer 16 to the electronic camera 10 the after-sales service data such as update data of an operation program of the electronic camera 10 which is recorded in association with the received identification information of the electronic camera itself and other update data of the operation program of the electronic camera 10 which is recorded in association with and at the same time based on, the status data and the history data related to the use of the electronic camera 10.

Accordingly, a service center performs an on-line communication with the electronic camera 10; hence the service center 20 can easily as well as precisely specify a condition of a problem without transporting the electronic camera 10 to a shop or an repairing store, and at the same time, the service center 20 can repair the electronic camera 10 with a correct decision of what to do.

As to a payment for the utilization charge of the customer service such as repairing, the charge may be received from the user in accordance with data related to a method of payment for the utilization charge to the service center 20 which is included in the user setting data, that is recorded in the record means in association with the received identification information of the electronic camera 10 itself.

Even in a case where an operation process program for controlling photographing and display is so updated as to be changed to a new program after the electronic camera 10 has been sold, the identification information of the electronic camera 10 itself is transmitted to the service center 20, whereby the service center 20 reads out a type of device of the electronic camera 10 recorded in association with the identification information of the electronic camera 10 itself and the utility data of the customer service from the record means such as a database, and transmits a relevant operation process program to the electronic camera 10 so as to execute updating of the operation process program. Furthermore, even though in a case where the electronic camera 10 has a trouble, the service center 20 reads out the data which is recorded in association with the identification information of the electronic camera 10 itself and can perform an appropriate determination and solution to the trouble.

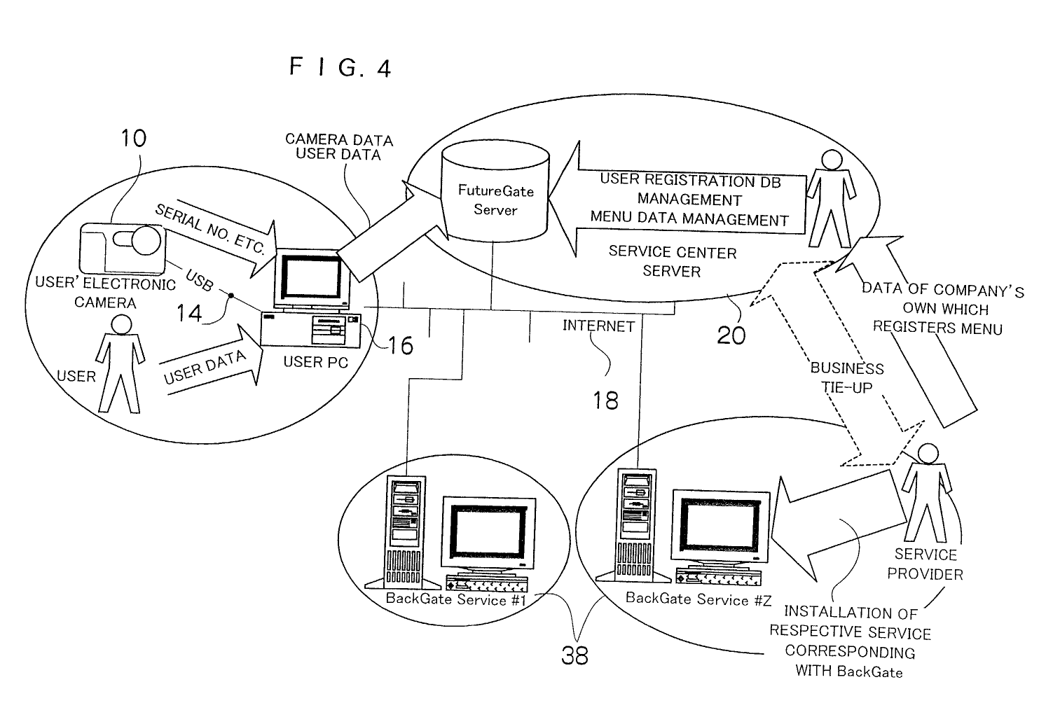

FIG. 4 shows a service system which transmits the user setting data inputted by the user and the identification information of the electronic camera 10 itself.

As seen from FIG. 4, the electronic camera 10 owned by the user transmits the identification information such as a serial number of the electronic camera 10 itself to the personal computer 16. The user inputs the user setting data to the personal computer 16. The identification information of the electronic camera 10 itself and the user setting data are transmitted to the service center 20 of the “FutureGate Server” through a communication network such as the Internet 18. In the “FutureGate Server”, the service data related to respective services and the service data of the company are received from a service provider, and the user setting data, the identification information of the electronic camera 10 itself, and the menu data are recorded.

The service provider also performs operations to each of a service center of the “BackGate Service” for incorporating the respective services corresponding with a back gate. The service center 38 of the respective “BackGate Service” processes delivery of prints and providing visual or audio data to the user.

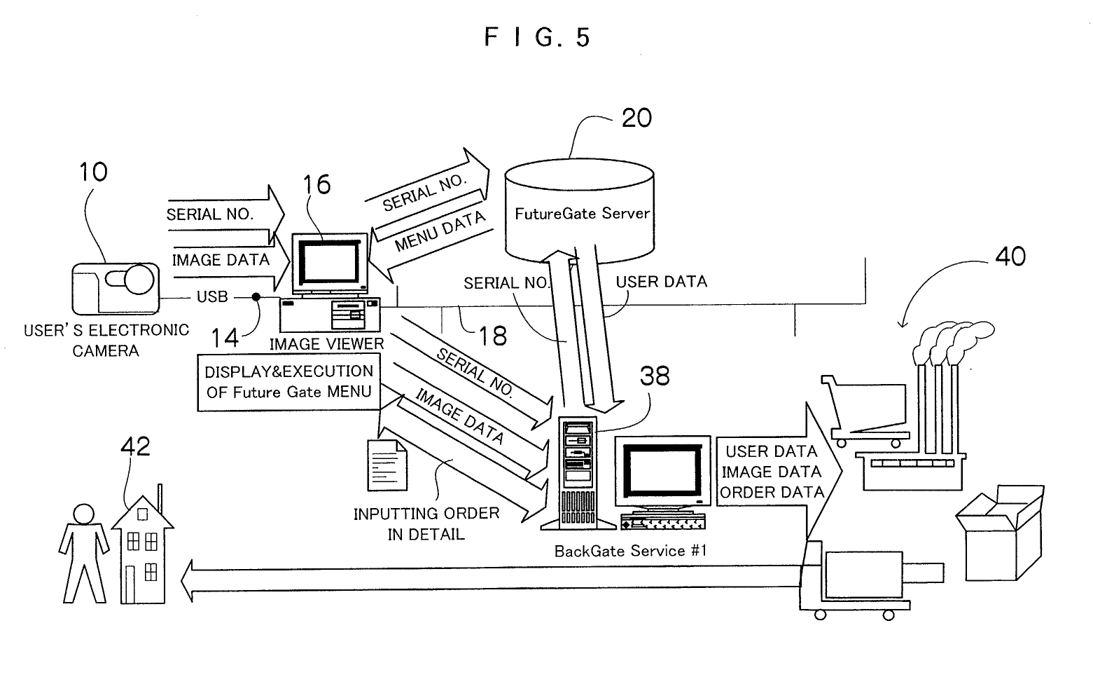

FIG. 5 shows an alternative use of the service system of the present invention.

As seen from FIG. 5, when connecting the electronic camera 10 owned by the user with the communication means 14, the program of the image viewer is automatically activated in the personal computer 16 and at the same time a connection with a communication network such as the Internet is started. The personal computer 16 transmits the identification information of the electronic camera 10 itself to “FutureGate Server” through the Internet 18. “FutureGate Server” picks up the service menu data related to a relevant service recorded in association with the received identification information of the electronic camera 10 itself, and transmits the data to the personal computer 16.

When the data such as the service menu is displayed on the image viewer, the user selects the desired image or sound, and a service, and instructs the desired data and service. The detailed order data of the service which is thus selected and the identification information of the electronic camera 10 itself are transmitted to the service center 38 of “BackGate Service” through the Internet. The service center 38 of “BackGate Service” transmits the received identification information of the electronic camera 10 itself to the service center 20 of “FutureGate Server”, and requests transmitting the user setting data. “FutureGate Server” receives the identification information of the electronic camera 1 0 itself, and transmits to “BackGate Service” the user setting data such as the address of the user to whom the product is delivered recorded in association with the identification information.

“BackGate Service” which received the user setting data transmits to a delivery service center 40 and the like the user setting data and the data of an image to be printed plus the detailed data of printing service. The delivery service center 40 which has received the above-mentioned data prints the product in accordance with the detailed order data, and delivers the product to the delivery address (a user's house 42) which is recited in the user setting data.

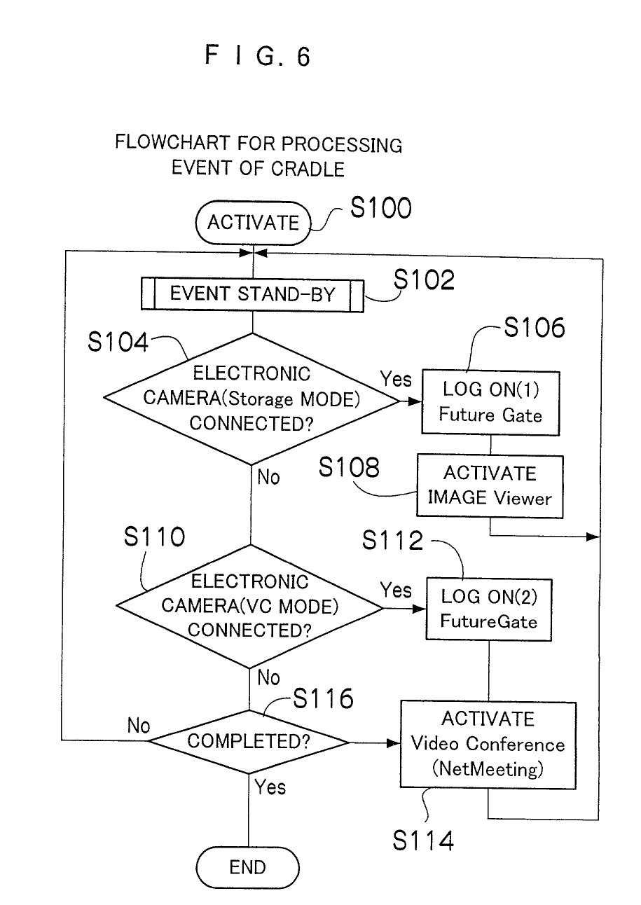

FIG. 6 is a flowchart for a process by a personal computer related to an event which has occurred when connecting the electronic camera with the cradle 12.

When the personal computer 16 is activated and the Plug & Play even process program of the cradle 12 is stationed, the process program of the personal computer 16 is divided into Step S100 “Activate” (hereafter the Steps will be recited as S100, for example). The process program then goes on to S102 “EVENT STAND-BY”, and the electronic camera 10 starts monitoring the event which is attached to the cradle 12. At S104 “ELECTONIC CAMERA (STORAGE MODE) CONNECTED?”, the process goes on to S106 “LOGON (1) FutureGate” if the electronic camera 10 is determined to be connected at the storage mode. At S106, logon to “FutureGate Server” is executed in order to take part in a communication network such as the Internet and exchange data. When the logon is completed normally, “FutureGate Server” transmits GUI data for an on-line registration to user who has not been registered in FutureGate. Even if the user does not register in the FutureGate and becomes an anonymous user or a visitor, the user can use only the image viewer afterwards by activating the image viewer at S108 “ACTIVATE IMAGE VIEWER”, which performs a process for activating the image viewer and returning to S102.

On the other hand, if the electronic camera 10 is determined to be connected in a mode other than the storage mode, the process goes on to the next S110 “ELECTRONIC CAMERA (VC MODE) CONNECTED?”, at which the process goes on to S112 “LOGON (2) FUTUREGATE” if the electronic camera 10 is determined to be connected at the “VC mode”. At S112, logon to “FutureGate Server” is executed in order to take part in a communication network such as the Internet 18 and exchange data in a video conference. When the logon is completed normally, a logon process to a locator service starts in order to find a partner in a net-meeting (the video conference). Moreover, the GUI data for on-line registration is transmitted to users who have not registered in FutureGate at that step. If not-registered users still do not formally register at that state, they cannot use the video conference service. At the next step S114 “ACTIVATE VIDEO CONFERENCE (NETMEETING)”, the video conference program is activated and a process for returning to S102 is performed.

On the other hand, if the electronic camera 10 is determined to be connected at a mode other than the VC mode at S110, the process goes on to S116 “COMPLETED?”, and whether or not to terminate the stand-by process for the event is determined. If continuation of the stand-by process for the event is instructed at S116, the process is divided into S102. If termination of the stand-by process for the event is instructed at S116, the process goes on to S118 “END” and the stand-by process for the event is completed.

A user ID to be used for executing logon to above-mentioned “FutureGate Server” enables the user to perform logon without being conscious of the user ID by using data such as the identification information of the electronic camera 10 itself which is notified from the electronic camera 10 through the communication means 14, and a serial number of USB which is transmitted when using the USB to the communication means 14. Usually, the user verifies a password which is currently inputted with the password which has been registered beforehand at a time of logon; however, after the second time verification, the personal computer 16 records the password previously recorded, so the logon can be automatically performed at the next verification without the password inputting process by the user.

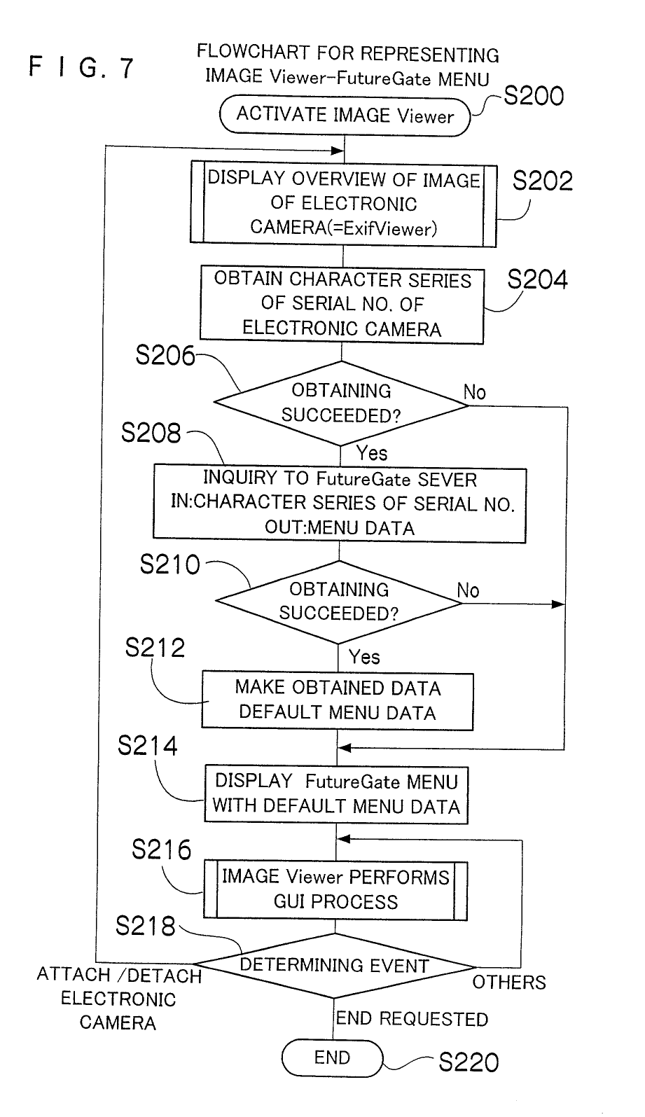

FIG. 7 is a flowchart related to activation of the image viewer and representing menu provided by FutureGate.

When connecting the electronic camera 10 with the cradle 12, the image viewer is automatically activated, but the image viewer can also be activated by operation of the personal computer 16 by the user when the electronic camera 10 is not connected.

When the image viewer is activated at S200 “ACTIVATE IMAGE VIEWER”, the process program of the image viewer goes on to S202 “DISPLAY OVERVIEW OF IMAGE OF ELECTRONIC CAMERA (=EXIFVIEWER)”, and starts communicating with the electronic camera 10 through the communication means 14, and reads out the images recorded in the record medium of the electronic camera 10, then displays an overview of the images or the reduced images on the screen 22.

At the next step S204 “OBTAIN CHARACTER SERIES OF SECIAL NO. OF ELECTRONIC CAMERA”, a character series of the serial number of the electronic camera 10 as an example of the identification of the electronic camera 10 itself is received through the communication means 14. Specifically, when the electronic camera 10 and the personal computer 16 exchange data through the communication means 14 of the USB, the character series of the serial number of the electronic camera 10 itself can be received from device descriptor at a time of Plug & Play.

At the next step S206 “OBTAINING SUCCEEDED?”, whether or not the serial number for the electronic camera 10 is obtained is determined. If the serial number for the electronic camera 10 is obtained at S206, the process goes on to S208 “INQURY TO FUTUREGATE SERVER, IN: CHARACTER SERIES OF SERIAL NO., OUT: MENU DATA”; if the serial number cannot be obtained, the process is divided into S214. At S208, the personal computer 16 transmits a serial number as the identification information of the electronic camera 10 itself to “FutureGate Server”, and “FutureGate Server” picks up relevant service menu data corresponding with the camera data recorded in a library of the database (record means) in the server by associating the service menu data with the identification information of the electronic camera 10 itself and transmits the data to the personal computer 16. At that stage, the menu data may be constructed by actively determining an order of priority for displaying the menu data among the plural menu data recorded in the database of the “FutureGate Server”, and the menu data may be transmitted to the personal computer 16.

Next, at S210 “OBTAINING SUCCEEDED?”, whether or not the service menu data is obtained from the “FutureGate Server” is determined. If the service menu data is obtained, the process goes on to S212 “MAKE OBTAINED DATA DEFAULT MENU DATA”, and a process is performed for recording the obtained service menu data as default menu data, then the process goes on to S214 “DISPLAY FUTUREGATE MENU WITH DEFAULT MENU DATA”. On the contrary, if the service menu data cannot be obtained at S210, the process program is divided and goes directly to S214.

At S214, a process is performed for displaying the default menu which is recorded at S212. Thus, initialized menu which has been incorporated is displayed just after installation of the image viewer. If communication with “FutureGate Server” has been performed before, a menu which was obtained is displayed.

At the next step S216 “IMAGE VIEWER PERFORMS GUI PROCESS”, the image viewer displays on the display screen 22 the visual or audio identification information recorded in the record medium of the electronic camera 10 and at the same time displays the latest service menu. As described before, the latest service menu is not merely displayed, but control is performed in which “FutureGate Server” receives and displays a menu for a download service of music only for a case where the electronic camera 10 is provided with music reproducing function, and performs other similar displays by using the identification information of the electronic camera 10 itself. Moreover, other control is also performed (a determination function for determining the order of priority for displaying the menu) such as one in which “FutureGate Server” identifies the user based on the identification information of the electronic camera 10 itself so that the order of priority for displaying the data of the menu items is switched for each of the users even though a type of the device is the same.

The user selects the desired image and sound, and the desired service by using GUI (Graphics User Interface) based on the visual or audio identification information and the service menu and the like which are displayed at S216, and the selected image and sound plus data related to the service are linked within the image viewer and are transmitted together.

Then, at S218 “DETERMINING EVENT”, the electronic camera 10 monitors the Plug & Play event detachable to the cradle 12 and also monitors a request for terminating the image viewer program by the user. If the electronic camera 10 is determined to be detached to the cradle 12 in a determination of S218, the process program is divided into S202; if terminating the image viewer program is determined to be requested from the user, the process goes on to S220 “END” so as to terminate the image viewer program. Otherwise, the process for returning to S216 is performed.

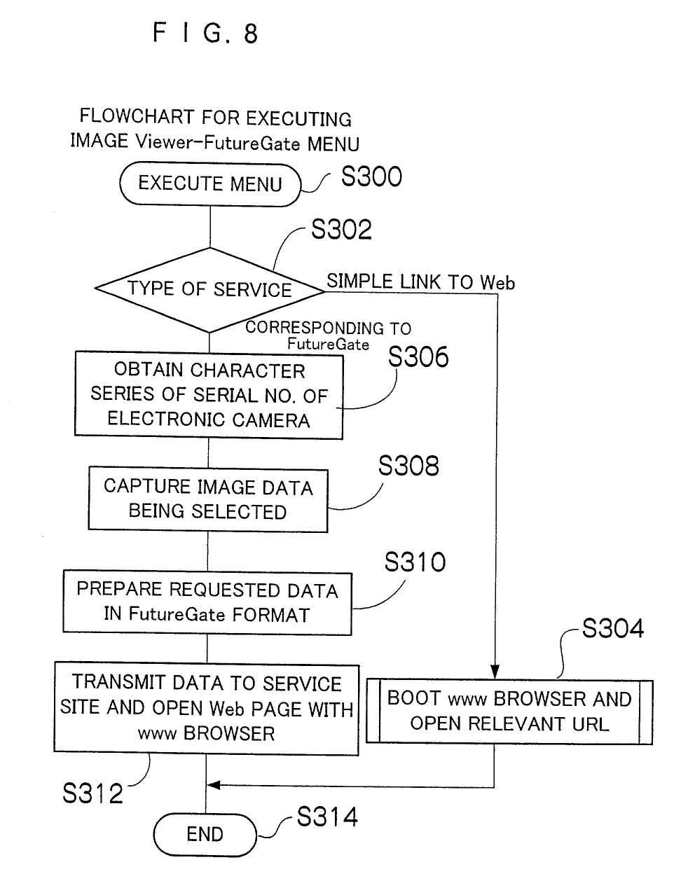

FIG. 8 is a flowchart related to execution of FutureGate menu of the image viewer.

A state of FutureGate menu is managed, in which the validity/invalidity of individual buttons of the FutureGate menu change between a time where an image within an overview display of the image viewer is clicked so as to be a selecting state and a time of non-selecting state where an image within the overview display of the image viewer has not been clicked. When a button which is set in a valid state at that time is clicked, the FutureGate menu is displayed.

As seen from FIG. 8, when executing the menu is instructed at S300 “EXECUTE MENU”, the process program goes on to a determination at S302 “TYPE OF SERVICE”. At S302, whether or not the type of service corresponds with FutureGate or with a simple Web link is determined. If the type of service corresponds with the simple Web link, the process program goes on to S304 “BOOT WWW BROWSER AND OPEN RELEVANT URL”, and a program for the web browser is activated and the URL data which is relevant to the program is transmitted, then a homepage of a desired service site is displayed.

If the type of service at S302 corresponds with FutureGate, the process program goes on to S306 “OBTAIN CHARACTER SERIES OF SERIAL NO. OF ELECTRONIC CAMERA”, and a character series of the serial number for the electronic camera as an example of the identification information of the electronic camera 10 itself is received through the communication means 14, then the process goes on to the next S308 “CAPTURE IMAGE DATA BEING SELECTED”.

At S308, a process is performed for receiving from the electronic camera 10 the visual and audio data selected by the user among the overall display of the image and sound, that are identified and displayed. When the receiving process is completed, data including the service data which is selected by the user among the service data displayed on the menu and the visual and audio data plus the identification information of the electronic camera 10 itself are formatted to be a required data in a common format at the next S310 “PREPARE REQUESTED DATA IN THE FUTUREGATE FORMAT”, and the data is transmitted at the next S312 “TRANSMIT DATA TO SERVICE SITE AND OPEN WEB PAGE WITH WWW BROWSER”. FutureGate Server which has received the required data in the common format picks up the user setting data recorded in the database in association with the identification information of the electronic camera 10 itself.

Moreover, since the image viewer activates the web browser, the user can look at a homepage of a desired service site. Usually, the user data and image plus sound should be selected from the top page after in an order and uploading should be performed on GUI of a WWW browser in order to inquire a service at the service site. However, since FutureGate Server receives the data in a format corresponding with FutureGate Server, the operation capability can be improved by eliminating a procedure for the above-mentioned uploading. The process after the elimination appears to the user like directly jumping into a web page by a short-cut route which comes out after executing procedures up to uploading of image and sound in a conventional technique.

When the user instructs to the personal computer 16 to terminate looking on the web, the process program goes on to the next S314 “END”.

As described hereinabove, the communication apparatus of the present invention comprises a first communication means for receiving an image and identification information of a camera itself which is owned by a user, a display means for displaying the image which is received from the camera and a service menu which indicates plural services provided by a service center, a selecting means for selecting an image which the user desires to select among the displayed images, and for selecting a service which the user desires to select among the service menu, and a second communication means for transmitting via a network the selected image, data indicating service, and the received identification information of the camera itself. Thus, the user can easily transmit visual or audio file and the identification information of the electronic camera itself to the desired server or the service center.

According to the present invention, the server comprises a communication means for receiving identification information of a camera itself from a user's side, and at the same time transmits a service menu to the user's side, a record means in which the identification information of the camera itself owned by the user and the service menu indicating plural services to be provided to the user are recorded, and a means for picking up a service menu from the record means based on the identification information of the camera itself when receiving the identification information of the camera itself from the user's side through the communication means, and transmitting the service menu to the user's side through the communication means. Thus, the server can pick up a relevant service menu which is recorded in association with the received identification information of the electronic camera itself and provide a desired service menu to the user.

Furthermore, according to the present invention, the service center comprises a communication means for receiving identification information of a camera itself or service data from a user's side, or the identification information of the camera itself and an image plus service data of the image from the user's side, a record means in which the identification information of the camera itself owned by the user and user setting data related to the user are recorded; and a means for picking up the user setting data from the record means based on the received identification information of the camera itself so as to specify the user, and for providing to the user a service corresponding with the received service data from the user's side. Therefore, the service center can pick up the user setting data which is recorded in association with the received identification information of the electronic camera itself, and can perform a providing or delivery service of a product to a location desired by the user.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A communication apparatus, comprising:
a first communication device that receives images and identification information of a camera owned by a user from the camera;
a displaying device that displays the images received from the camera by the first communication device and displays a service menu showing services offered by a service center for the user;
a selecting device that selects an image among the images displayed by the displaying device and selects a service among the services displayed by the displaying device; and
a second communication device that transmits the identification information, the image and information indicating the service to the service center through a network.

2. The communication apparatus as defined in claim 1, wherein:
the first communication device automatically starts communicating with the camera when the user connects the camera with the first communication device; and
the second communication device starts communicating with the service center through the network as need arises.

3. A server, comprising:
a communication device that receives identification information of a camera owned by a user from the user;
a recording device that records the identification information and a service menu showing services to be offered to the user; and
a reading device that reads the service menu from the recording device according to the identification information;
wherein the communication device transmits the service menu to the user.

4. The server as defined in claim 3, further comprising:
a payment information recording device that records the identification information and a method of payment;
a payment method reading device that reads the method of payment from the payment information recording device according to the identification information received; and
a charge receiving device that receives a charge for a service in accordance with the method of payment read by the payment method reading device.

5. A server, comprising:
a communication device that receives identification information of a camera owned by a user from the user;
a recording device that records the identification information and user information on the user; and
a device that reads the user information from the recording device according to the identification information and transmits the user setting information to another communication apparatus.

6. The server as defined in claim 5, wherein the user information includes at least one of the following: a delivery address, a distribution destination of image or audio data, a financial source, a password, an address, a name, a gender, a birthday and an age.

7. The server as defined in claim 5, further comprising:
a payment information recording device that records the identification information and a method of payment;
a payment method reading device that reads the method of payment from the payment information recording device according to the identification information received; and
a charge receiving device that receives a charge for a service in accordance with the method of payment read by the payment method reading device.

8. A server, comprising:
a communication device that receives identification information of a camera owned by a user from the user;
a recording device that records the identification information and utility data showing services used by the user;
a reading device that reads the utility data from the recording device according to the identification information; and
a determining device that determines an order of services in a service menu to be offered to the user in accordance with the utility data;
wherein the communication device transmits the service menu showing the services in the order determined by the determining device.

9. A server, comprising:
a communication device that receives identification information of a camera owned by a user and a password of the user from the user;
a recording device that records the identification information and a password;
a verifying device that reads the password from the recording device according to the identification information and verifies the password received by the communication device with the password read; and
a device that allows services to the user when the passwords are the same and prohibits the services to the user when the passwords are different.

10. A service center, comprising:
a communication device that receives identification information of a camera owned by a user and service information, or the identification information, an image and the service information from the user;
a recording device that records the identification information and user information on the user; and
a device that reads the user information from the recording device according to the identification information received by the communication device to specify the user, and provides a service corresponding with the service information to the user.

11. The service center as defined in claim 10, wherein the user information includes at least one of the following: a delivery address, a distribution destination of image or audio data, a financial source, a password, an address, a name, a gender, a birthday and an age.

12. The service center as defined in claim 10, further comprising:
a payment information recording device that records the identification information and a method of payment;
a payment method reading device that reads the method of payment from the payment information recording device according to the identification information received; and
a charge receiving device that receives a charge for a service in accordance with the method of payment read by the payment method reading device.

13. The service center as defined in claim 10, wherein the service includes at least one of the following: an image or audio distributing service, an image printing service, a service for publicly opening an image on a network, and a service for saving an image in a server.

14. The service center as defined in claim 13, wherein the user information includes at least one of the following: a delivery address, a distribution destination of image or audio data, a financial source, a password, an address, a name, a gender, a birthday and an age.

15. The service center as defined in claim 13, further comprising:
a payment information recording device that records the identification information and a method of payment;
a payment method reading device that reads the method of payment from the payment information recording device according to the identification information received; and
a charge receiving device that receives a charge for a service in accordance with the method of payment read by the payment method reading device.

16. A service center which offers an after-sales service on a camera owned by a user in response to a request from the user, the service center comprising:
a communication device that receives identification information of the camera from the user;
a recording device that records the identification information and after-sales service information; and
a reading device that reads the after-sales service information from the recording device according to the identification information;
wherein the communication device transmits after-sales service data to the user.

17. The service center as defined in claim 16, wherein the after-sales service information is updating information of a program for the camera.

18. A service center which offers an after-sales service on a camera owned by a user in response to a request from the user, the service center comprising:
a communication device that receives identification information of the camera and at least one of status information of the camera and history data related to utilization of the camera from the user;
a recording device that records the identification information, one of the status information and the history information, and after-sales service information of the camera; and
a reading device that reads the after-sales service information from the recording device according to the identification information and the one of the status information and the history information,
wherein the communication device transmits the after-sales service information to the user.

19. The service center as defined in claim 18, wherein the after-sales service information is updating information of a program for the camera.

20. A service method, comprising the following steps of:
receiving images from a camera connected with a communication apparatus and identification information of the camera from the camera;
displaying the images and a service menu showing services to be offered by a service center on a displaying device of the communication apparatus;
selecting a service from the service menu, or selecting the service and an image among the images; and
transmitting the identification information and information indicating the service selected, or the identification information, the information indicating the service and the images through a network.

21. The service method as defined in claim 20, wherein:
the communication apparatus connects to the service center and transmits the identification information and the image to the service center;
the server which communicates with the communication apparatus through the network has a recording device that records the identification information and user information on the user; and
the server reads the user information from the recording device on reception of the identification information from the service center and transmits the user information to the service center.

22. The service method as defined in claim 20, wherein:
the communication apparatus transmits the identification information, the image and information the service to the server through the network;
the server has a recording device that records the identification information and the user information, and reads the user information from the recording device according to the identification information; and
the server connects to the service center and transmits the user information and the image to the service center.

23. The service method as defined in claim 20, wherein:
the server which communicates with the communication apparatus through the network has a recording device that records the identification information and a password of the user; and
the server reads the password from the recording device according to the identification information on reception of the identification information and a password from the user, and verifies the password received from the user with the password read from the recording device, then allows the service when the passwords are the same and prohibits the service when the passwords are different.

24. The service method as defined in claim 20, wherein:
a server which communicates with the communication apparatus through the network has a recording device that records the identification information and the service menu; and
the server selects the service menu from the recording device on reception of the identification information from the user and transmits the service menu to the user.

25. The service method as defined in claim 24, wherein:
the communication apparatus connects to the service center and transmits the identification information and the image to the service center;
the server which communicates with the communication apparatus through the network has a recording device that records the identification information and user information on the user; and
the server reads the user information from the recording device on reception of the identification information from the service center and transmits the user information to the service center.

26. The service method as defined in claim 24, wherein:
the communication apparatus transmits the identification information, the image and information the service to the server through the network;
the server has a recording device that records the identification information and the user information, and reads the user information from the recording device according to the identification information; and
the server connects to the service center and transmits the user information and the image to the service center.

27. The service method as defined in claim 24, wherein:
the server which communicates with the communication apparatus through the network has a recording device that records the identification information and a password of the user; and
the server reads the password from the recording device according to the identification information on reception of the identification information and a password from the user, and verifies the password received from the user with the password read from the recording device, then allows the service when the passwords are the same and prohibits the service when the passwords are different.

28. The service method as defined in claim 20, wherein:
a server which communicates with the communication apparatus through the network has a recording device that records the identification information and utility information related to services used by the user; and
the server reads the utility information from the recording device on reception of the identification information from the user, determines an order of the services in the service menu in accordance with the utility information, and transmits the service menu in the order to the user.

29. The service method as defined in claim 28, wherein:
the communication apparatus connects to the service center and transmits the identification information and the image to the service center;
the server which communicates with the communication apparatus through the network has a recording device that records the identification information and user information on the user; and
the server reads the user information from the recording device on reception of the identification information from the service center and transmits the user information to the service center.

30. The service method as defined in claim 28, wherein:
the communication apparatus transmits the identification information, the image and information the service to the server through the network;
the server has a recording device that records the identification information and the user information, and reads the user information from the recording device according to the identification information; and
the server connects to the service center and transmits the user information and the image to the service center.

31. The service method as defined in claim 28, wherein:
the server which communicates with the communication apparatus through the network has a recording device that records the identification information and a password of the user; and
the server reads the password from the recording device according to the identification information on reception of the identification information and a password from the user, and verifies the password received from the user with the password read from the recording device, then allows the service when the passwords are the same and prohibits the service when the passwords are different.

32. A service method in which a recording device records identification information of a camera owned by a user and user information on the user, and at least one of the following is offered: an image or audio distributing service, an image printing service, a service for publicly opening an image on a network, and a service for saving an image in a server, said service method comprising the steps of:
receiving the identification information and service information indicating a service, or receiving the identification information, an image and the service information from the user; and
reading the user information from the recording device according to the identification information to specify the user, and providing the service to the user.

33. The service method as defined in claim 32, in which a recording device records the identification information and a method of payment, wherein said service method further comprising the steps of:
reading a method of payment from the recording device in accordance with the identification information; and
receiving a charge for the service from the user in accordance with the method of payment.

34. A service method in which a recording device records identification information of a camera owned by a user and after-sales service information indicating an after-sales service of the camera, and the after-sales service is provided to the user, said service method comprising the steps of:
receiving the identification information from the user;
reading the after-sales service information from the recording device in accordance with the identification information; and
transmitting the after-sales service information to the user.

35. The service method as defined in claim 34, in which a recording device records the identification information and a method of payment, wherein said service method further comprising the steps of:
reading a method of payment from the recording device in accordance with the identification information; and
receiving a charge for the service from the user in accordance with the method of payment.

36. A service method in which a recording device records identification information of a camera owned by a user, at least one of status information of the camera and history information related to utilization of the camera, and after-sales service information indicating an after-sales service of the camera, and the after-sales service is provided to the user, said service method comprising the steps of:
receiving the identification information and at least one of the status information and the history information from the user;
reading the after-sales service information from the recording device in accordance with the identification information and at least one of the status information and the history information; and
transmitting the after-sales service information to the user.

37. The service method as defined in claim 36, in which a recording device records the identification information and a method of payment, wherein said service method further comprising the steps of:
reading a method of payment from the recording device in accordance with the identification information; and
receiving a charge for the service from the user in accordance with the method of payment.
